(19) United States
(12) Patent Application Publication
(10) Pub. No.: US 2008/0039132 A1
(43) Pub. Date: Feb. 14, 2008

(54) Dual-Mode Terminal Access To A First Radiocommunication Network And To A Second Local Communications Network

(75) Inventors: Yannick Delibie, Thorigne-Fouillard (FR); Jacques Mathe, Penvenan (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Wavecom, Issy-Les-Moulineaux Cedex (FR)

(21) Appl. No.: 10/582,201

(22) PCT Filed: Dec. 9, 2004
(86) PCT No.: PCT/FR04/03178

§ 371 Date: Apr. 16, 2007

(30) Foreign Application Priority Data
Dec. 11, 2003 (FR) 0314552

(51) Int. Cl. H04M 1/00; H04Q 7/24

(52) U.S. Cl. 455/552.1; 370/338

(57) ABSTRACT

The disclosure relates to a dual-mode terminal for accessing to at least first radiocommunications network in a first operating mode and to at least one local communication network in a second operating mode. The dual-mode terminal includes means for detecting the presence of said terminal, at least according to location information related thereto, in a geographic service area associated with said second network, known as a positive presence, and means for connecting, in the case of said positive presence, to the second network in such a way that the terminal operates in priority in said second mode.

### CROSS-REFERENCE TO RELATED APPLICATION

This Application is a Section 371 National Stage Application of International Application No. PCT/FR2004/0003178, filed Dec. 9, 2004 and published as WO 2005/060290 on Jun. 30, 2005, not in English.

### FIELD OF THE DISCLOSURE

The field of the disclosure is that of radiocommunications. More specifically, the disclosure relates to a dual-mode terminal for accessing, in a first operating mode, a radiocommunication network, and, in a second operating mode, a local communication network.

### BACKGROUND

Dual-mode terminals, capable of connecting to two distinct communication networks, are already known.

Thus, for example, some cellular telephones are compatible with European radiocommunication networks on the one hand, and North American radiocommunication networks on the other hand. Depending on the continent where the user is located, the user can then manually select, using a menu on his terminal, the network to which he wishes to connect with his cellular telephone.

However, to switch from one operating mode to the other, and from one communication network to the other, an intervention by the terminal user is always necessary.

When both networks are simultaneously available and accessible for the terminal, the latter always operates on one of the networks, until the user manually changes the operating mode.

However, depending on the user's situation, one of the networks may be more suitable than the other, in terms of services, transmission quality, bandwidth availability, or cost, for example.

A disadvantage of this prior art technique is therefore that, if the user forgets to change the operating mode of his cellular telephone, the latter may establish calls via a less efficient or more costly network than another network also available to which he could have access.

To overcome this problem, it has also been envisaged to design dual-mode radiocommunication terminals in which the choice of the communication network of which the services are used by the terminal is made without the user's intervention. In this case, the cellular telephone is programmed so that it always attempts first to connect to the first communication network, before any call is established. Thus it is only when the first network is not available, or is inaccessible to the terminal, that the latter chooses to use the services of the second network.

This solution is particularly advantageous when the first network has better overall performance (wider range of services, better transmission quality, greater bandwidth available, better geographic coverage, etc.) or is less expensive than the second network.

However, a disadvantage of this prior art technique is that the terminal always attempts first to use the services of the first network, even when it is not accessible (typically, when the user is outside the area of geographic coverage of the first network), which is resource-intensive for the terminal. In particular, such futile connection attempts are highly energy-consuming, and lead to premature failure of the cellular telephone battery.

### SUMMARY

An embodiment of the present invention is directed to a dual-mode terminal allowing access, in a first operating mode, to at least one first radiocommunication network, and, in a second operating mode, to at least one second local communication network.

According to an embodiment of the invention, such a dual-mode terminal includes means for detecting, on the basis of at least one information item on the location of said terminal, the presence of said terminal in a geographic coverage area associated with said second network, a so-called positive presence, and means, which are activated in the case of a positive present, for connecting to said second network, so that said terminal then operates first in said second mode.

Thus, an embodiment of the invention is based on an entirely novel and inventive approach to dual-mode terminals. Indeed, an embodiment of the invention proposes taking into account the geographic position of the calling cellular telephone, PDA, or portable computer, so as to select the operating mode, and therefore the communication network to which the terminal will attempt to connect.

Unlike in the prior art techniques, the user no longer needs to intervene in order to select the network to which he wishes to connect: this selection is made automatically by the terminal. The terminal also no longer attempts to connect systematically to the second network, which is energy-consuming; indeed, the connection means are activated only after the terminal has detected that it is located in an area potentially covered by the second network, and therefore that this connection attempt may be successful.

An embodiment of the invention is particularly advantageous when it is applied to a fleet of mobile terminals of a company, for example, capable of connecting either to a GSM, GSM/GPRS or UMTS radiocommunication network, for example (first network), or to the WLAN (“Wireless Local Area Network”) local communication network of the company, for example (second network). Indeed, when the user is located at one of the sites of the company (research centre, production plant, warehouses, financial services, etc.), covered by the second network, his cellular telephone automatically switches to the local communication network of the company, enabling it to make calls at a low cost. However, when the user leaves the grounds of the company to travel or to attend a meeting, his cellular telephone automatically switches to the first network, without requiring the user to perform any manipulation whatsoever.

Thus, the employees of the company no longer use the first radiocommunication network, in which communications are costly, to make internal calls.

Preferably, in the case of a positive presence, said dual-mode terminal operates according to said second mode when it is in communication with a terminal also present in a geographic coverage area associated with said second network.

Said location information advantageously belongs to the group including:

an identifier of a cell of said first radiocommunication network to which said dual-mode terminal is connected;

a GPS (“Global Positioning System”) geographic position of said terminal;

an AGPS (“Assisted Global Positioning System”) geographic position of said terminal;

a Galileo-type geographic position of said terminal.

It is noted that Galilea (registered trademark) is the name of the European geolocation network, and that, in the AGPS system, a GPS position is determined which is specified by the operator of a radiocommunication network, in relation to a cell identifier of the network in which the user is located.

According to an advantageous feature of an embodiment of the invention, said detection means implement a comparison between said information on the location of said terminal and a list of location information corresponding to a geographic coverage area associated with said second network, called a coverage list, stored in said terminal.

Said connection means preferably include means for identifying (“ATTACH”) said terminal by an access server for accessing said second network and means for registering (“REGISTER”) said information on the location of said terminal by a registration server of said second network, wherein said registration server manages location information associated with a set of predetermined terminals.

For example, if the second local communication network is a private company network, the registration server can manage location information associated with all of the dual-mode terminals of the company fleet.

Said dual-mode terminal advantageously includes means for storing at least one connection profile for connecting said terminal to said second network, wherein each of said connection profiles associates at least one parameter for connection to said second network with one of said location information items of said coverage list.

As will be seen in greater detail below, the dual-mode terminal can thus know that, when it located in cell no. X covered by the second local communication network, it can access the services of the latter via an access point whose address it has stored in the connection profile associated with cell no. X.

Said connection parameter preferably belongs to the group including:

an identifier of said access server (or access point);

an identifier of said registration server;

an SIP (“Session Initiation Protocol”) address of said terminal in said second network;

an identifier of said terminal in said first network.

According to an advantageous alternative embodiment, said connection profile(s) also include at least one application parameter of said second network. Thus, the dual-mode terminal can also access certain application services of the second network, such as a shared calendar, and so on.

Said application parameter preferably belongs to the group including:

an identifier of the domain name server DNS of said second network;

an identifier of the HTTP or FTP proxy server of said second network;

an IP (“Internet Protocol”) address of said terminal in said second network;

an identifier of the SMTP (“Simple Mail Transfer Protocol”) server of said second network.

Said connection profile(s) advantageously also include at least one parameter for authentication of said terminal in said second network.

Thus, the security of the second network is increased, for example, by requiring the terminal to be authenticated by means of a “login” and a password before being capable of accessing the services of the local network.

Said dual-mode terminal preferably includes means for forced activation of said connection means, in the case that the positive presence is not detected, wherein said connection means implement said last connection parameter(s) used by said terminal.

Thus, when the terminal does not detect that it is located in an area covered by the second network (for example due to a dynamic reconfiguration of the cell identifiers performed by the operator), but its user knows that he is physically located in such an area, he can force the terminal to attempt to use the services of the second network, on the basis of the last connection parameters stored.

Such a dual-mode terminal advantageously includes means for configuration of said connection profile, enabling, when said positive presence is not detected but said terminal is successfully connected to said second network, said location information stored in said profile to be updated using current location information on said terminal.

Thus, the coverage list is updated again, for example, after a dynamic reconfiguration of the cell identifiers by the network operator.

Said first radiocommunication network preferably belongs to the group including:

GSM (“Global System for Mobile Communications”) networks;

GPRS (“General Packet Rate Service”) networks;

UMTS (“Universal Mobile Telecommunication System”) networks;

CDMA (“Code Division Multiple Access”) networks.

Said second local communication network is preferably a WLAN (“Wireless Local Area Network”) network, also called WiFi (registered trademark, “Wireless Fidelity”).

According to an advantageous feature of an embodiment of the invention, said dual-mode terminal belongs to the group including:

cellular telephones;

PDAs (“Personal Digital Assistant”);

portable computers.

Such a dual-mode terminal can of course also take the form of any other calling terminal capable of moving and accessing two distinct types of communication networks.

Other features and advantages will become clearer from the following description of a preferred embodiment, given by way of a simple illustrative and non-limiting example, and appended drawings.

### BRIEF DESCRIPTION OF THE DRAWINGS

FIG. 1 shows an illustrative diagram of a dual-mode terminal capable of accessing, according to the mechanism of an embodiment of the invention, a first radiocommunication network and a second local communication network;

FIG. 2 shows the mechanism for establishing a call by the dual-mode terminal of FIG. 1;

FIG. 3 shows the protocol stack of the dual-mode terminal of FIG. 1;

FIG. 4A and 4C show the various servers of the local communication network, and their exchanges with the dual-mode terminal of FIG. 1, when a call is established with a receiving terminal;

FIG. 5 shows an example of the application of an embodiment of the invention in a company having a plurality of geographically distinct sites.

### DETAILED DESCRIPTION OF ILLUSTRATIVE EMBODIMENTS

The general principle of an embodiment of the invention is based on the use of information on the location of a dual-mode radiocommunication terminal, so as to determine whether it is located in an area potentially covered by a local communication network, and thus attempt first to use the services of this local network, rather than those of a conventional radiocommunication network.

In the rest of the description, a specific application of an embodiment of the invention to a fleet of dual-mode terminals of a company distributed over a plurality of distinct geographic sites will be described. An embodiment of the invention is of course in no way limited to this specific application, and is more generally of interest for any dual-mode terminal capable of accessing a radiocommunication network as well as a local communication network, whether this terminal is for personal or professional use.

An embodiment of the invention applies in particular to any type of calling terminal, whether a telephone, a PDA, a computer, and so on.

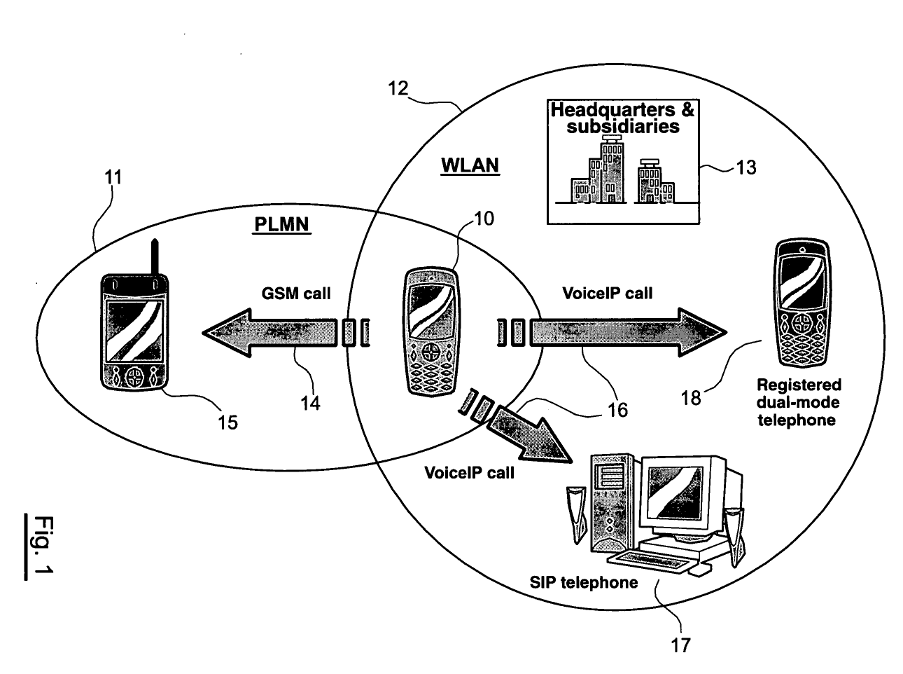

FIG. 1 shows an example of a dual-mode terminal 10, capable of accessing first, PLMN (“Public Land Mobile Network”), communication network 11 and a second, WLAN (“Wireless Local Area Network”), communication network 12.

The PLMN network 11 is managed by a service operator and, in the example of FIG. 1, is consistent with the GSM standard. The WLAN network 12 is a private network, for example a company network. Access to the WLAN network is wireless, but the private network per se can be a wire network. For example, in the case of a company, each office can be equipped with a base to which the dual-mode terminal 10 can connect by radio relay channel, with the different bases being mutually connected by a cable network. The private network 12 can also be a wireless network.

In the example of FIG. 1, the dual-mode terminal is located in a geographic area covered by the WLAN network 12, i.e. the grounds of the headquarters, one of the sites or one of the subsidiaries of the company 13. It can therefore:

establish a GSM-type call 14 with a terminal 15 (for example a PDA) not accessible by the WLAN network 12;

establish a VoiceIP-type call 16 (call implementing an Internet protocol with another terminal of the WLAN network 12. This other terminal can be a SIP (“Session Initiation Protocol”, namely a signalling channel for a Voice Over IP service), or another dual-mode telephone registered as present in the WLAN network 18.

FIG. 2 shows in greater detail the mechanism implemented when the dual-mode terminal 10 wants to establish a call with one of the terminals 15, 17, 18 of FIG. 1. It is assumed that the dual-mode terminal 10 is located in a geographic area covered by the private WLAN network 12.

When the dual-mode terminal 10 20 activates the call functionality, it is first determined 21 who the recipient of said call is, according to the telephone number entered on the keypad by the user. The identifier of this recipient is stored, in the telephone directory of the dual-mode terminal 10, in association with the GSM telephone number (for example, in the form +33614151617), and optionally with the SIP address (for example, in the form john.doe@nowhere.com), if this terminal has access rights to the private WLAN network 12 (i.e. if the terminal belongs to the same fleet of company terminals). If the SIP address of the recipient is not available 22, the call with the latter will be made in GSM mode 26, via the PLMN network 11.

If, however, the SIP address of the recipient 22 is known, it is determined, on the basis of location information associated therewith (according to a mechanism that will be described later in this document), whether the recipient is located in a geographic area potentially covered by the WLAN network 12 (for example, one of the sites of the company or one of its subsidiaries, possibly abroad).

If not, the call will be established (26) by the GSM PMLN network 11. If so, it is determined whether the recipient is actually capable of being reached 24. Indeed, the recipient can be located in an area associated with the WLAN network 12, but for all practical purposes be outside the scope of this network. As will be seen below, this is the case in particular when the position of the terminal is determined on the basis of the identifier of the GSM cell in which it is located; the receiving terminal can then be located in a cell of the PLMN network 11 where one of the company sites is located, but be physically away from this site (when the cell is much larger than the company site, for example). If the recipient can be reached, a SIP call is established 25. Otherwise, the call between the dual-mode terminal 10 and the recipient will be a GSM-type call (26).

As will be seen in greater detail below, the establishment of the SIP transaction 25 requires the knowledge of specific connection parameters of the WLAN network 12, such as the address of a registration server (or REGISTRAR), and/or a proxy server.

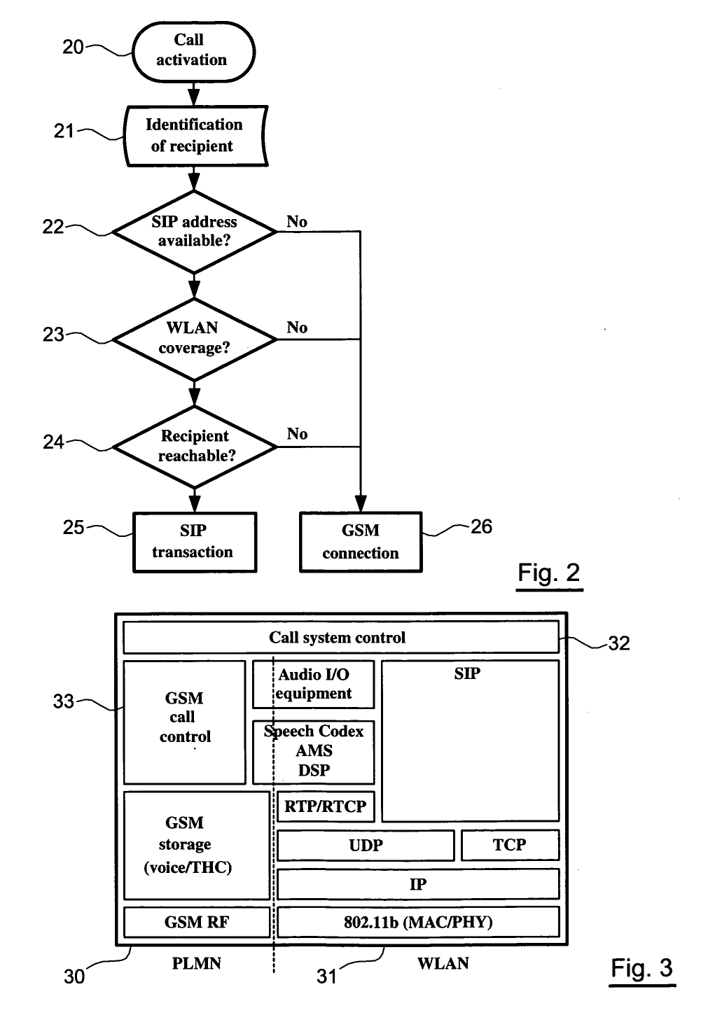

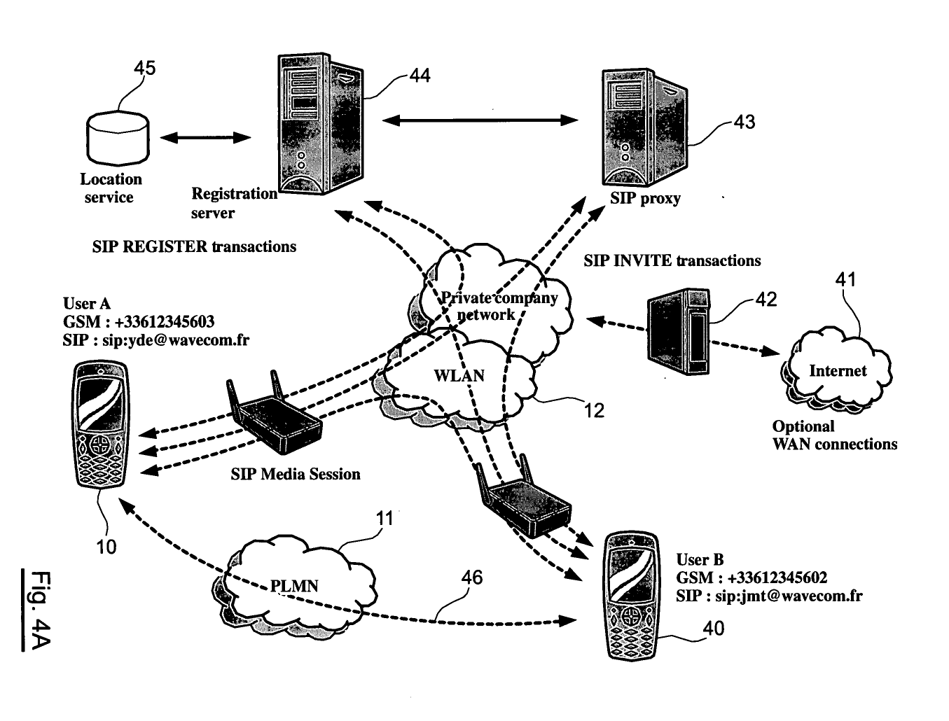

FIG. 3 shows the structure of the protocol stack of a dual-mode terminal 10 according to an embodiment of the invention.

This stack includes two assemblies 30 and 31 respectively dedicated to the functionalities of the public LMN network 11 and the private WLAN network 12. Each of the layers of these sets is conventional, and will not therefore be described here in greater detail.

Only the control layer of the call system 32 and the GSM call control 33 include functionalities specific to the implementation of an embodiment of the invention, and the management of location information.

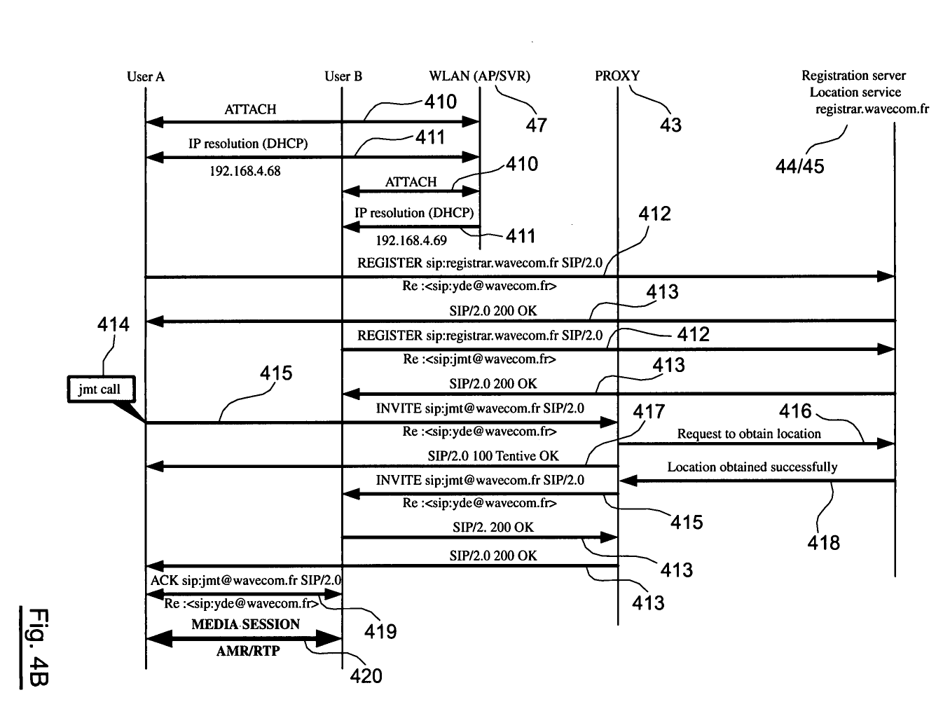

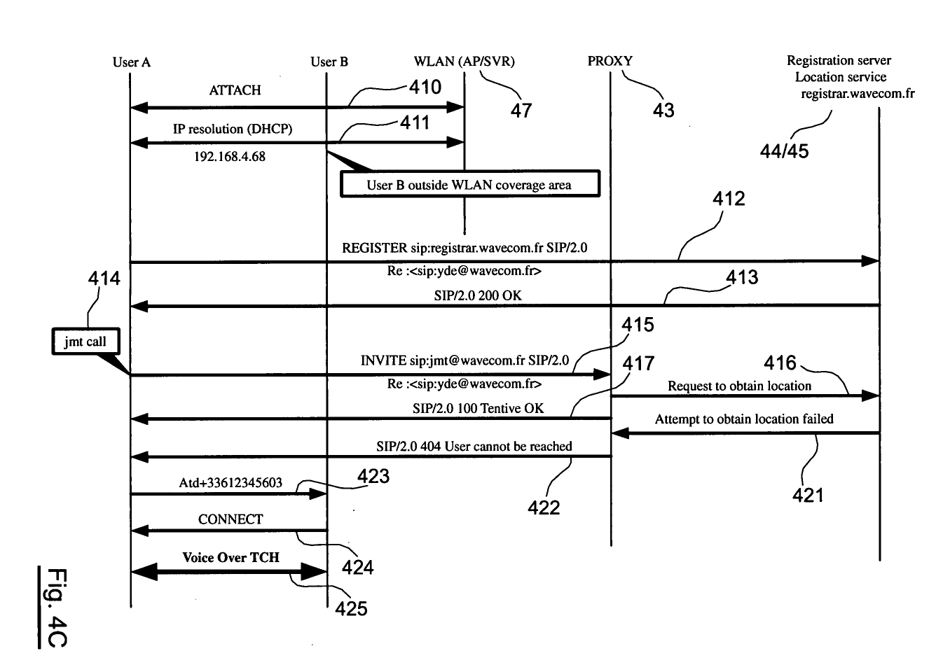

We will now describe, in relation to FIGS. 4A to 4C, the various servers of the private WLAN network 12 communicating with the dual-mode terminal 10, when the latter wants to establish a call with a receiving terminal also present in the WLAN network (FIG. 4B), or absent from said network (FIG. 4C).

Terminal 10 is that of a user A, identified by his GSM telephone number (+33612345603) and by his SIP address in the private WLAN network 12 (yde@wavecom.fr).

In the example of FIGS. 4A to 4C, it is considered that user A is located in a geographic area covered by the private WLAN network 12. For example, the dual-mode terminal 10 has determined to which base station of the GSM network 11 it has been connected, and has deduced therefrom the cell (identified by its CellId) of the GSM network 11 in which it is located. After comparing the identifier of this cell with a coverage list stored in the terminal, corresponding to the list of all of the GSM cells in which the company has offices or a site, the dual-mode terminal 10 derives therefrom whether or not it is present in an area potentially covered by the WLAN network 12. If so, it attempts to connect to the private WLAN network 12, as described in greater detail below in relation to FIGS. 4B and 4C.

To do this, the dual-mode terminal 10 registers with the registration server, or REGISTRAR 44, of the WLAN network 12, by providing the latter with its SIP address (SIP REGISTER transactions). The REGISTRAR 44 then records in the location service 45 that the dual-mode terminal 10, with the SIP address yde@wavecom.fr, is located at one of the company sites. As shown in FIG. 4A, when it has accessed the private WLAN network 12, the dual-mode terminal 10 can:

transmit requests to the SIP proxy server 43 of the private company network 12, for example in order to access certain resources of the WLAN network 12 (shared calendar management, bandwidth allocation, electronic mail consultation, etc.), in the form of SIP INVITE transactions;

access the Internet 41, optionally via the firewall 42 protecting the local network 12. To do this, optional WAN (“Wide Area Network”) connections can be established;

establish a call with a user B. This user B may not belong to the company: the call must then be made via the PLMN network 11, as represented by the arrow 46. If the terminal of user B belongs to the fleet of dual-mode mobile terminals of the company, it is identified by its GSM subscriber number (+33612345602), and by its SIP address (jmt@wavecom.fr). If it is present in one of the areas covered by the WLAN network 12, user A can establish a call with it via the private company network 12 (FIG. 4B). Otherwise, the call between users A and B will be a GSM call (FIG. 4C).

FIG. 4B shows more specifically the establishment of a call between users A and B, when they are both present and authorized to connect to the private WLAN network 12.

After having detected that it is located in an area potentially covered by the WLAN network 12 (on the basis of the CellId of the GSM cell in which it is located, or its GPS position, for example), the terminal 10 of user A activates means for connection to the WLAN network 12. To do this, it launches an ATTACH procedure 410 with the server 47 acting as a point of access to the WLAN network 12 (AP/SVR).

The access server 47 sends user A an IP resolution confirmation (DHCP) 411.

User B, after detecting his presence in an area potentially covered by the WLAN network, proceeds in the same way.

Users A and B then register with the registration server 44 of the private network 12, by a REGISTER request 412. The REGISTRAR 44 stores, in the location service 45, the SIP address of users A and B, associated with an indication of the presence of corresponding terminals in the area of coverage of the private network 12.

The REGISTRAR 44 then sends to each of the users A and B a registration confirmation 413.

It should be noted that, if the company is distributed over a plurality of geographically separate sites, there is at least one REGISTRAR 44 and at least one access server 47 for each site.

Once these registration procedures have been completed, users A and B are both effectively connected to the private network 12.

When user A wants to establish a call with user B 414, he sends an INVITE message 415 to the proxy server 43. This INVITE message 415 includes, as parameters, the SIP address of user A and the SIP address of the recipient B. It is noted that a proxy server is an intermediate entity that acts both as server and as client in order to transmit requests in the name of other clients.

Upon receipt of the INVITE message 415, the proxy server 43 transmits, to the registration server 44, a request 416 to obtain the location of user B, so as to determine whether the latter is present within the boundaries of one of the company sites, and therefore accessible via the WLAN network 12. Simultaneously, the proxy server 43 confirms 417 to user A that it has transmitted the request 416 to obtain location information.

When, after consultation of the location service 45, the registration server 44 determines that user B is registered as being present in the WLAN network 12, it sends a message 418 to the proxy server 43, confirming that user B can be reached via the private company network 12.

The proxy server 43 then contacts user B, by an INVITE message 415, with, as parameters, the SIP address of the caller yde@wavecom.fr, and the SIP address of user B jmt@wavecom.fr. User B then confirms 413 receipt of this message to the proxy server 43, which confirms it 413 to user A.

User A sends an acknowledgement ACK 419 to user B, and an AMR/RTP (“Adaptive Multi-Rate/Real-time Transport Protocol”) call 420 is then established between the terminals of these two users. It is noted that the acronym AMR designates a specific wireless voice codec, and that the acronym RTP designates a UDP/IP support protocol for Voice Over IP services.

FIG. 4C shows a similar mechanism, but in which user B is not located in a geographic area covered by the WLAN network 12.

We will not describe in detail the steps, which are similar to those of FIG. 4B (namely the ATTACH procedure 410 of user A with the access server 47, and the registration procedure 412 with the REGISTRAR 44). It is noted that the same elements are designated with the same numeric references in all of the figures, and in particular FIGS. 4A to 4C.

As in FIG. 4B, user A, when he wants to call 414 user B, sends an INVITE message 415 to the proxy server 43, which then sends a request 416 to obtain the location of user B to the registration server 44, and a confirmation 417 to user A.

Unlike in the case of FIG. 4B, as user B is not within the boundaries of one of the company sites, the registration server 44, after having consulted the location server 45, responds 421 to the proxy server 43, indicating that user B is not registered as being present in the private WLAN network 12. The proxy server 43 transmits this information to user A, in the form of an SIP message 422 indicating that user B cannot be reached.

User A then contacts 423 user B via the GSM network 11, identifying himself by means of his GSM telephone number +33612345603. When user B accepts the connection 424, a Voice Over TCH call 425 is then established between users A and B, by the PLMN radiocommunication network 11.

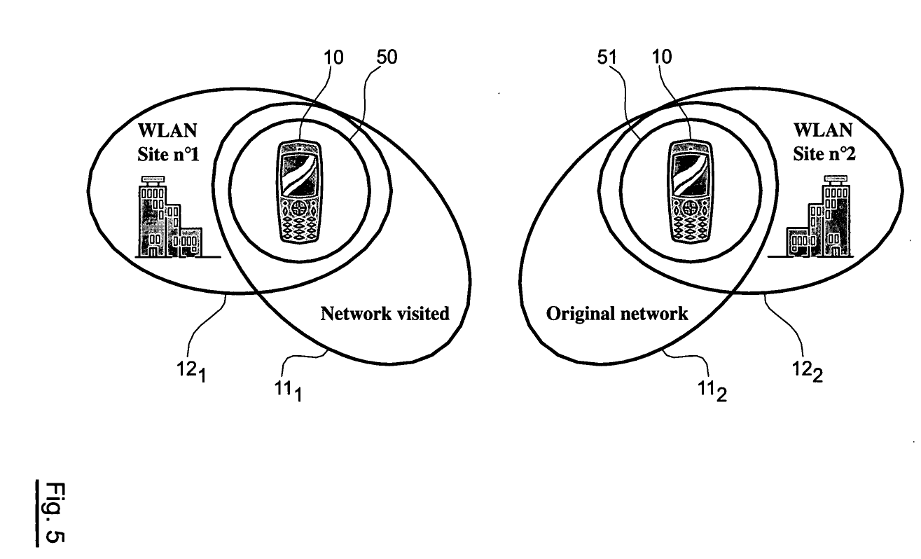

FIG. 5 shows in greater detail the case of a multi-site company, of which the offices may be distributed over distant geographic areas. For example, the company has its headquarters in Europe and a subsidiary in Asia. Each of these sites is covered by a private WLAN network: the Asian subsidiary, called site no. 1, is equipped with a first private WLAN network 12₁, and the European headquarters, called site no. 2, is equipped with a second private WLAN network 12₂.

The dual-mode terminal 10 is connected to its original public PLMN network 11₂. When it is located in the cell 51 of this network 11₂, it can access both the WLAN network 12₂ of the company's European headquarters and the original public PLMN network 11₂.

According to an embodiment of the invention, it is possible for the dual-mode terminal 10 to store, in its coverage list, the GSM cell identifiers of all of the company's sites, and therefore in particular the cell identifier 50 of its Asian subsidiary. Thus, then the user of the dual-mode terminal 10 is travelling in Asia, and connects to the PLMN network visited 11₁, the dual-mode terminal 10 can detect his presence in the GSM cell 50, and deduce therefrom that he is near the private WLAN network 12₁ of the Asian subsidiary. The terminal 10 can then automatically switch to local operating mode, via the private WLAN network 12₁, so as to be capable of making calls at low cost, to other terminals of the company's mobile fleet, even if they are located within the boundaries of the European headquarters.

Profiles for access to the private networks 12₁ and 12₂ can be stored in the dual-mode terminal 10, associated with each of the cell identifiers 50, 51 (it is noted that the location can also be based on GPS information, for example, and not a GSM cell identifier). These profiles can include basic connection parameters (such as the configuration of the WLAN network access point 12₁, 12₂, i.e. the address of the server for accessing 47 each of the European and Asian sites, or the VPN (“Virtual Private Network”) configuration, and optionally application parameters (address of the registration server 44 and a proxy server 43 of each of the sites, etc.).

All of these parameters can be preconfigured in the dual-mode terminal 10, or be the subject of a learning phase. The latter alternative is particularly advantageous, when the location information is a PLMN network cell identifier, so as to deal with the phenomenon of dynamic reconfiguration of cells by the network operator 11.

Indeed, the CellId, or GSM cell identifier, is managed by the network operator, and can therefore be modified dynamically without the users of the network being informed.

Thus, the dual-mode terminal 10 is capable of having recorded that the GSM cell 50 was associated with the company's Asian subsidiary. However, when the user travels again in Asia, if the operator in the meantime has performed a dynamic reconfiguration of the PLMN network visited 11₁, the dual-mode terminal 10 will no longer recognise, on the basis of the identifier of the cell in which it is located, that he is present in the boundaries of the company's Asian subsidiary; the dual-mode terminal 10 will not therefore automatically choose to use the local WLAN network services 12₁.

However, if the user knows that he is located at one of the company's sites, he can launch a learning phase with his dual-mode terminal 10, so as to update the stored coverage list. The dual-mode terminal 10 then launches an automatic lock-on phase on the antenna of the base station of the closest public PLMN network 11₁, and deduces therefrom the identifier of the cell in which it is located, which therefore corresponds to the company's Asian subsidiary.

It then attempts to connect to the private WLAN network 12₁, based on connection parameters, and optionally application parameters, that it has stored in the connection profile associated with this Asian subsidiary of the company (in relation to the former CellId stored for this subsidiary). If this connection is possible, the dual-mode terminal 10 simply updates the coverage list with the new identifier of the cell in which it is located, as well as the associated connection profile.

The connection profile of the terminal 10 for a specific site of the company can also contain access rights specific to the applications available on the local WLAN network. Thus, it is possible for the user of a dual-mode terminal 10 based at the company's European headquarters to have access, via the local European WLAN network 12₂, to all of the applications of this network (shared calendar management, e-mail servers, etc.) but for these access rights to the local WLAN network 12₁ of the Asian subsidiary to be limited (for example, only electronic mail consultation).

Other services can also be accessible to the user of the dual-mode terminal 10 when he occasionally travels to Asia, such as, for example, the one-off purchase of bandwidth, in order to satisfy a temporary need to download files.

The connection profile of the dual-mode terminal 10 can also contain authentication parameters, such as an access name (or “login”) and a password. Thus, access to the local network visited 12₁ is secure.

An embodiment of the invention provides a dual-mode terminal, allowing for access to at least two distinct communication networks, in which the choice of the communication network used can be made without the user's intervention.

An embodiment of the invention proposes such a dual-mode terminal that is resource-efficient, and in particular prevents premature battery failure.

An embodiment of the invention also aims to provide such a dual-mode terminal that always enables the highest-performing and/or the least expensive network to be used first when it is available.

An embodiment of the invention also aims to propose such a dual-mode terminal that attempts to connect to a communication network only after confirmation that this network is actually accessible.

An embodiment of the invention provides a dual-mode terminal that is simple to design and produce, and inexpensive to use.

Although the present invention has been described with reference to preferred embodiments, workers skilled in the art will recognize that changes may be made in form and detail without departing from the spirit and scope of the invention.

1. Dual mode A dual-mode terminal comprising:
a first operating mode allowing for access to at least one radiocommunication network,
a second operating mode allowing for access to at least one second local communication network,
means for detecting, on the basis of at least one information item on the location of said terminal, the presence of said terminal in a geographic coverage area associated with said second network, called positive presence, and
means, which are activated in the case of positive presence, for connecting to said second network, so that said terminal then operates first in said second mode, wherein said detection means implement a comparison between said information on the location of said terminal and a list of location information corresponding to said geographic coverage area associated with said second network, called a coverage list, stored in said terminal.

2. The dual-mode terminal according to claim 1, wherein the case of positive presence, the terminal operates according to said second mode when it is in communication with another terminal also present in a geographic coverage area associated with said second network.

3. The dual-mode terminal according to claim 1, wherein said location information belongs to the group including:
an identifier of a cell of said first radiocommunication network to which said dual-mode terminal is connected;
a GPS (“Global Positioning System”) geographic position of said terminal;
an AGPS (“Assisted Global Positioning System”) geographic position of said terminal; and
a Galileo-type geographic position of said terminal.

4. The dual-mode terminal according to claim 1, wherein said means for connecting include means for identifying said terminal by an access server for accessing said second network and means for registering said information on the location of said terminal by a registration server of said second network, wherein said registration server manages location information associated with a set of predetermined terminals.

5. The dual-mode terminal according to claim 1, wherein the terminal includes means for storing at least one connection profile for connecting said terminal to said second network, wherein each of said connection profiles associates at least one parameter for connection to said second network with one of said location information items of said coverage list.

6. The dual-mode terminal according to claim 5, wherein said connection parameter belongs to the group including:
an identifier of an access server for accessing said second network;
an identifier of a registration server of said second network;
an SIP (“Session Initiation Protocol”) address of said terminal in said second network;
an identifier of said terminal in said first network.

7. The dual-mode terminal according to claim 5, wherein said connection profile(s) also include at least one application parameter of said second network.

8. The dual-mode terminal according to claim 7, wherein said application parameter belongs to the group including:
an identifier of the domain name server DNS of said second network;
an identifier of the HTTP or FTP proxy server of said second network;
an IP (“Internet Protocol”) address of said terminal in said second network;
an identifier of the SMTP (“Simple Mail Transfer Protocol”) server of said second network.

9. The dual-mode terminal according to claim 5, wherein said connection profile(s) also include at least one parameter for authenticating said terminal in said second network.

10. The dual-mode terminal according to claim 5, wherein the terminal includes means for forced activation of said connection means, if a positive presence is not detected, wherein said connection means then implement said last connection parameter(s) used by said terminal.

11. The dual-mode terminal according to claim 10, wherein the terminal includes means for configuration of said connection profile, enabling, when said positive presence is not detected but said terminal is successfully connected to said second network, said location information stored in said profile to be updated using current location information on said terminal.

12. The dual-mode terminal according to claim 1, wherein said first radiocommunication network belongs to the group including:
GSM (“Global System for Mobile Communications”) networks;
GPRS (“General Packet Rate Service”) networks;
UMTS (“Universal Mobile Telecommunication System”) networks;
CDMA (“Code Division Multiple Access”) networks.

13. The dual-mode terminal according to claim 1, wherein said second local communication network is comprises a WLAN (“Wireless Local Area Network”) network.

14. The dual-mode terminal according to claim 1, wherein the terminal belongs to the group including:
cellular telephones;
PDAs (“Personal Digital Assistant”);
portable computers.

15. A dual-mode terminal comprising:
a first operating mode allowing for access to at least one radiocommunication network,
a second operating mode allowing for access to at least one second local communication network,
a detector, which detects, on the basis of at least one information item on the location of said terminal, a presence of the terminal in a geographic coverage area associated with the second network, called positive presence, and
a connector, which is activated in the case of positive presence and responsively connects to the second network, so that the terminal then operates first in the second mode, wherein the detector implements a comparison between the information on the location of the terminal and a list of location information corresponding to the geographic coverage area associated with the second network, called a coverage list, stored in the terminal.

16. The dual-mode terminal according to claim 15, wherein in the case of positive presence, the terminal operates according to the second mode when it is in communication with another terminal also present in a geographic coverage area associated with the second network.

17. The dual-mode terminal claim 15, wherein the connector includes means for identifying the terminal by an access server for accessing the second network and means for registering the information on the location of the terminal by a registration server of the second network, wherein the registration server manages location information associated with a set of predetermined terminals.

18. The dual-mode terminal according to claim 15, wherein the terminal includes means for storing at least one connection profile for connecting the terminal to the second network, wherein each of the connection profiles associates at least one parameter for connection to the second network with one of the location information items of the coverage list.
